(19) United States
(12) Patent Application Publication
(10) Pub. No.: US 2015/0192335 A1
(43) Pub. Date: Jul. 9, 2015

(54) HEAT EXCHANGER FACILITY

(71) Applicant: Vacuwatt AS, Randaberg (NO)

(72) Inventor: Petter Dahle Melhus, Stavanger (NO)

(73) Assignee: Vacuwatt AS, Randaberg (NO)

(21) Appl. No.: 14/410,746

(22) PCT Filed: Jun. 25, 2013
(86) PCT No.: PCT/NO2013/050117

§ 371 Date: Dec. 23, 2014

(30) Foreign Application Priority Data
Jun. 25, 2012 (NO) 20120734

(51) Int. Cl. F25B 43/00; C02F 1/04; C09K 5/04; F25B 30/02

(52) U.S. Cl. CPC F25B 43/00; F25B 30/02; C02F 1/04; C09K 5/048

(57) ABSTRACT

The invention provides a heat pump installation comprising an evaporator, a pressure regulator and a heat pump medium, as heat is collected from a cold side of the installation in that the heat pump medium is evaporated in the evaporator, gaseous fluid is lead to the condenser where heat is given off by condensation and the condensed fluid is led to a pressure regulator. The heat pump installation is characterised in that it also comprises a vacuum appliance or a compressor arranged between the evaporator and the condenser, and the heat pump medium is fresh water, saltwater or another liquid that is evaporated at a low temperature under vacuum in the evaporator or/and the installation uses steam as a feed. Method for the operation of the installation, and also application thereof. In preferred embodiments the installation produces fresh water and electricity.

### AREA OF THE INVENTION

The present invention relates to heat pumps, energy production and production of fresh water. In more detail, the invention relates to a heat pump installation that can deliver heat at a sufficiently high temperature to be able to produce electric energy and which furthermore can be used for the production of fresh water and as a part of an installation for production of salt.

Background to the invention and prior art The heat pumps of today can deliver energy in the form of heat at temperatures up to about 112° C. This achieved by the use of water/ammonia as a cooling medium, at a condensing pressure of 65 bar. The maximum delivery temperature is, in the main, governed by the cooling medium that is used, but also by pressure and requirement of degree of efficiency. Lower delivery temperatures are achieved with cooling agents such as hydrofluorocarbons, such as R 134a, 245 and CO₂. It is desirable to have a higher delivery temperature to make it easier to be able to produce electricity from the heat energy.

At the same time, there is a shortage of fresh water in many places, and there is an increasing need for installations that produce fresh water. There is also a demand for salt.

The aim of the present invention is to provide a technology that is relevant both for the production of electricity and production of fresh water, and furthermore can be used in an installation for the production of salt.

### SUMMARY OF THE INVENTION

The invention provides a heat pump installation, comprising an evaporator, a condenser, a pressure regulator and a heat pump medium, as heat is collected at the cold side of the installation in that heat pump medium is evaporated in the evaporator, gaseous medium is led to the condenser where heat is given off by condensation, and the condensed liquid is led to the pressure regulator. The heat pump installation is characterised in that it also comprises a vacuum appliance or a compressor arranged between the evaporator and condenser, and the heat pump medium is fresh water, saltwater or other liquid that is evaporated at a low temperature under vacuum in the evaporator or/and the installation uses steam as a feed.

Meant by the concept of vacuum is pressure lower than the atmospheric pressure, meant by the concept of evaporated at low temperature under vacuum is that the medium is evaporated at a lower temperature than the boiling point of the medium at atmospheric pressure. Meant by the concept heat pump medium is the liquid medium fed into the evaporator in an open installation, or the medium that is circulated in the heat pump loop if the installation is closed. An open installation means that the heat pump installation is not a closed loop, heat pump medium such as saltwater is fed in and medium is led out, that is fresh water evaporated from the saltwater and, in addition, the remaining saltwater, typically designated brine is led out. In an open installation the heat pump medium is not, saltwater, similar to the gaseous medium, fresh water evaporated from saltwater. A closed installation means that the installation forms a closed loop so that medium is not led into or out of the loop.

The vacuum appliance can be nearly any type of vacuum appliance, such as an ejector or other Venturi appliances, but most preferred is a vacuum pump compressor because a pressure increasing side makes the installation more suited to production of electric energy. Meant by the concept vacuum pump compressor is a vacuum pump that, through its function, is a vacuum creating unit on the suction side and at the same time a compression unit, a compressor, on the delivery side. A compressor, on the other hand, works with pressures above atmospheric pressure on the low pressure side also.

The heat pump medium is preferably saltwater or fresh water, saltwater is more preferred in an open installation which thereby gives production of fresh water, or fresh water in a closed installation which can thereby produce electricity efficiently, most preferred is saltwater in one or more open steps connected in series, possible closed final steps with fresh water to get a sufficiently high temperature and pressure for connection of equipment for an efficient production of electric energy. Most preferred is the heat pump medium saltwater and the gaseous medium is thereby fresh water, but the installation can have closed loops in heat exchange or for production of electricity containing another fluid.

The heat pump installation according to the invention is different from previously known installations in several ways. Firstly, there are no known installations that use a vacuum pump compressor, which means that the installation operates at a lower pressure than atmospheric pressure on the evaporator side. Other installations use a compressor, that is the low pressure side operates at a pressure higher than atmospheric pressure, typically 3 bar with R 134 in the installation. Secondly, there are no known installations that use water. Thirdly there are no known installations that use saltwater or brackish water in an open installation which thereby also produces fresh water. Fourthly, there are no known installations that have such high differential temperature per pressure increase, so that the medium in the installation can efficiently be compressed up to deliver heat at very high temperatures, suitable for efficient production of electricity.

Advantageously, the installation comprises two or more vacuum pump compressors arranged in series, which give better efficiency because of large gas volumes at low pressure and low differential pressure at low pressures, so that the gaseous medium is brought more efficiently to a higher pressure and a higher condensing temperature. In some preferred embodiments, in the last step or in places in the installation where the pressure has come above atmospheric pressure, one or more compressors, driven by electrical or/and mechanical energy, are arranged to raise the pressure to a high condensing temperature for efficient production of electricity. With the help of the vacuum pump, or other equivalent units, or more precisely and most preferred the vacuum pump compressor, saltwater can be evaporated at a low temperature, with the help of the compression the steam can be condensed at high temperature, in preferred embodiments at temperatures suited to an efficient production of electricity.

It is an advantage for the installation to have an inlet for saltwater, an outlet for fresh water and an outlet for brine (remaining non-evaporated saltwater), as liquid fed in to the evaporator is preferably saltwater in the form of seawater or brackish water, the fresh water is preferably of a quality suited to agriculture, industry or drinking water, while the brine is preferably used as a feed to an installation for salt production.

The temperature whereby the saltwater boils depends on the pressure, as the pressure above the saltwater must be kept low with the vacuum appliance to ensure a low evaporation temperature, typically 40-60° C. At, for example, 1° C. water boils/evaporates when the pressure is less than 0.006571 bar. Water vapour will then condense at a pressure above 0.006571 bar. At 20° C., this pressure will be 0.02339 bar, at 40° C., 0.07384 bar, 60° C., 0.1995 bar, 80° C., 0.4741 bar. The heat source on the cold side of the installation must have a temperature above the evaporating pressure, which depends on the degree of vacuum. The cold side of the installation, that is the evaporator and/or one or more associated or closely arranged heat exchangers are preferably connected in heat exchange to one or more of: a sun catching installation; a geothermal installation; the condenser in an air condition installation; industrial heat; district heat, the condensed liquid from the warm side of the installation, the flow of brine out of the installation and any other heat sources present.

The warm side of the installation, the condenser and/or one or more associated or closely arranged heat exchangers are connected in heat exchange to or comprises one of more of: an installation for the production of electricity, such as an organic Rankin cycle, a kalina installation, an installation with a volumetric turbine connected to a generator, or a binary cycle; a drying installation; a district heat installation; a heat store.

The saltwater in the installation can, completely or partially, be led in a loop or circle, similar to a traditional heat pump cycle, or the saltwater can be led through the installation once. Preferably, the saltwater that is led into the cold side of the installation can continuously rinse out the remaining brine, salt deposits and any algae. For the production of fresh water, evaporated water is taken out as fresh water, completely or partially, as at least the corresponding amount of water which is taken out fresh water and brine must be replaced in the form of saltwater continuously or batchwise and a continuous through-flow of a suitable volume prevents deposition of salt and the bloom of algae.

In one embodiment of the installation the vacuum pump is preferably connected to a steam containing upper part of an evaporation installation comprising a number of horizontally lying pipe elements arranged as sun catchers, as the evaporation installation makes up the evaporator. This is a particularly advantageous embodiment in hot climates with much strong sun, such as desert areas near the ocean. A corresponding embodiment is also preferential in areas with geothermal heat near the surface, as the whole or parts of the evaporation installation can be put into the ground or against the hot ground. For an evaporation installation of said type the seawater inlet is arranged under water so that only seawater, and no air, is led into the installation to prevent that the vacuum installation must be removed, in this connection, air that cannot be used.

In a preferred embodiment of the present invention, steam from any source is used as a feed, as the vacuum pump compressor or compressor in the installation compresses the steam to a high pressure and high condensing temperature, and the installation is connected in heat exchange to or comprises one or more of: an installation for the production of electricity, such as an organic Rankin cycle, a kalina installation, an installation with a volumetric turbine connected to a generator, or a binary cycle; a drying installation; a district heat installation; a heat store or set of turbine generators placed directly in the stream of steam. Steam is used in addition to, or instead of, seawater or other water, thus the installation comprises a dedicated inlet for steam and any regulating appliances between the feed streams.

The invention also provides a heat pump installation which is characterised in that it comprises a vacuum pump compressor or compressor which, in the installation, compresses a feed in the form of steam to a high pressure and a high condensation temperature, and the installation is connected in heat exchange to or comprises one or more of an installation for the production of electricity, such as an organic Rankin cycle, a kalina installation, an installation with a volumetric turbine connected to a generator, or a binary cycle; a drying installation; a district heat installation; a heat store or a set of turbine generators placed directly in the steam stream. Said installation comprises not necessarily an evaporator, if the access to steam is continuous, electricity can be produced continuously with the installation without any other feed. If the feed steam is held below atmospheric pressure a vacuum pump compressor is used in the first compression step, if the feed steam holds atmospheric pressure or higher a compressor is used in the first compression step and the installation can comprise several compressor steps in series dependent on the desired pressure and condensation temperature on the warm side of the installation. Said installation is an open installation with feed steam in and condensed fresh water out if the installation does not comprise an evaporator. Today, many industrial processes produce steam that is difficult to find any use for, with the present invention the steam can be used in the production of electricity.

The invention provides a method for operation of an installation according to the invention, characterised in that seawater is fed into an evaporator where underpressure leads to evaporation of fresh water at a reduced temperature, while the remaining brine is led out. Seawater is fed in by an amount which in sum corresponds to the amount taken out of fresh water condensed from the steam and taken out brine, and electrical energy or/and heat energy is produced in the installation in addition to fresh water and brine. A necessary through-flow of saltwater/brine is advantageously maintained to prevent deposition of salt and algal blooms in the evaporator.

The invention also provides use of an installation according to the invention for the production of fresh water and/or production of electricity and/or heat and/or brine.

The installation according to the invention can encompass features that are described or illustrated here, in any operative combination, said combinations are embodiments of the present invention. The method according to the invention can encompass features or steps that are described or illustrated here, in any operative combination, said combinations are embodiments of the present invention.

### FIGURES

The invention is illustrated with the help of four figures, where

FIG. 1 illustrates a simple, closed installation according to the invention,

FIG. 2 illustrates a simple, open installation according to the invention,

The FIGS. 3 and 4 illustrate more complicated open installations according to the invention.

### DETAILED DESCRIPTION

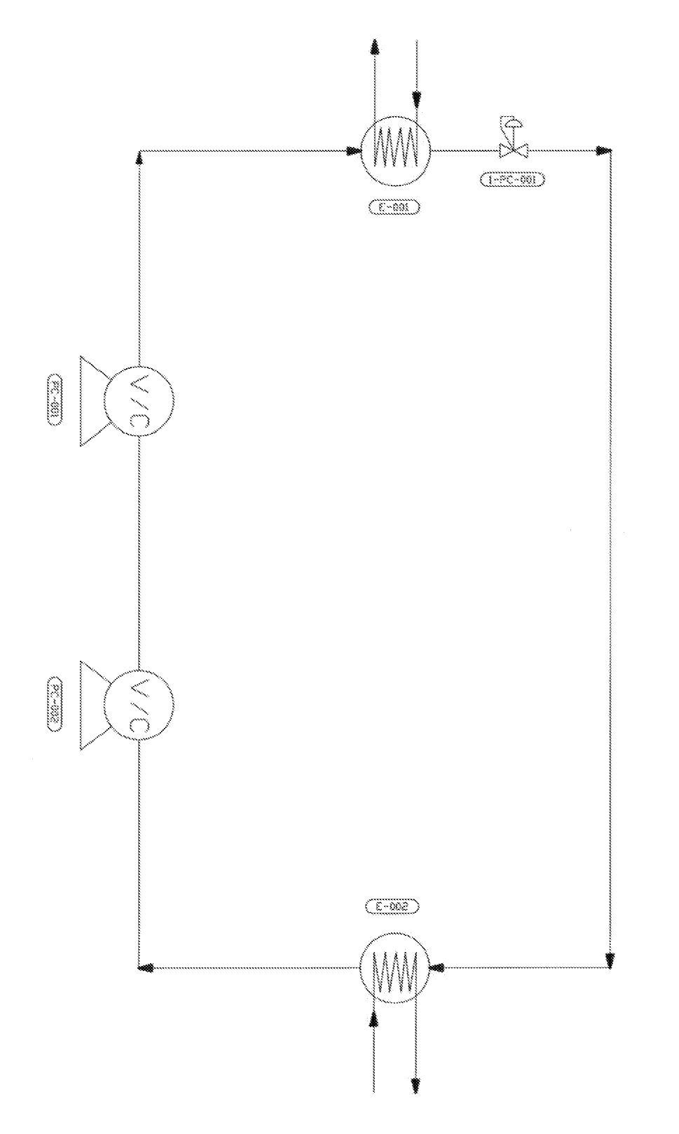

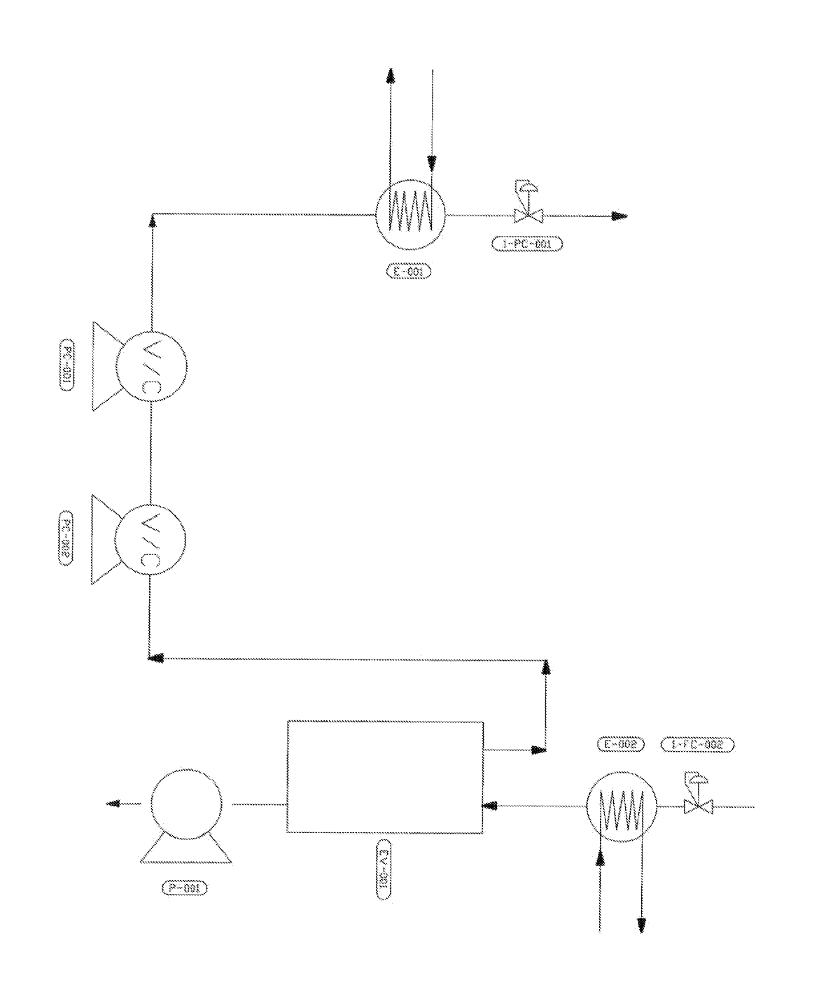

Reference is given to FIG. 1 which illustrates a simple, closed installation according to the invention. In more detail, the installation comprises an evaporator E-002 in the form of a heat exchanger, a vacuum pump compressor PC-002, a further vacuum pump compressor PC-001, a condenser E-001 in the form of a heat exchanger and a pressure regulator 1-PC-001. A heat pump medium, such as fresh water, which is circulated in the closed installation, collects heat on the cold side of the installation by being evaporated in the evaporator E-002, at underpressure in relation to the atmospheric pressure, with the help of the vacuum pump compressor PC-002 arranged downstream of the evaporator. Gaseous medium, such as steam, is led to the vacuum pump compressor PC-001 where the medium is compressed before it is led to the condenser E-001 where heat is given off by condensation, and the condensed liquid is led to the pressure regulator 1-PC-001 and from there back to the evaporator. The vacuum pump compressor PC-001 represents one or more units in series, with which the pressure in the steam can be increased considerably to be able to produce electricity more efficiently, for example, in a separate loop connected to the condenser E-001. The highest known temperature that can be taken out of a heat pump with the use of today's technology is, as mentioned, by the use of water/ammonia where a condensing temperature of 112° C. is achieved at a condensation pressure of 65 bar. With the use of the installation according to the invention the condensing temperature will be 281° C. at 65 bar, much suited to the above installation for the production of electricity. The very strong pressure dependency for the condensation temperature is essential for the suitability for the production of electricity because a high delivery temperature can be reached with a limited compression work. If one compresses steam to 5 bar (4 bar above atmospheric pressure) the condensation temperature will increase to 152° C. With this pressure and temperature the steam will contain 2748 kJ/kg enthalpy. Media other than water can also be used as a heat pump medium.

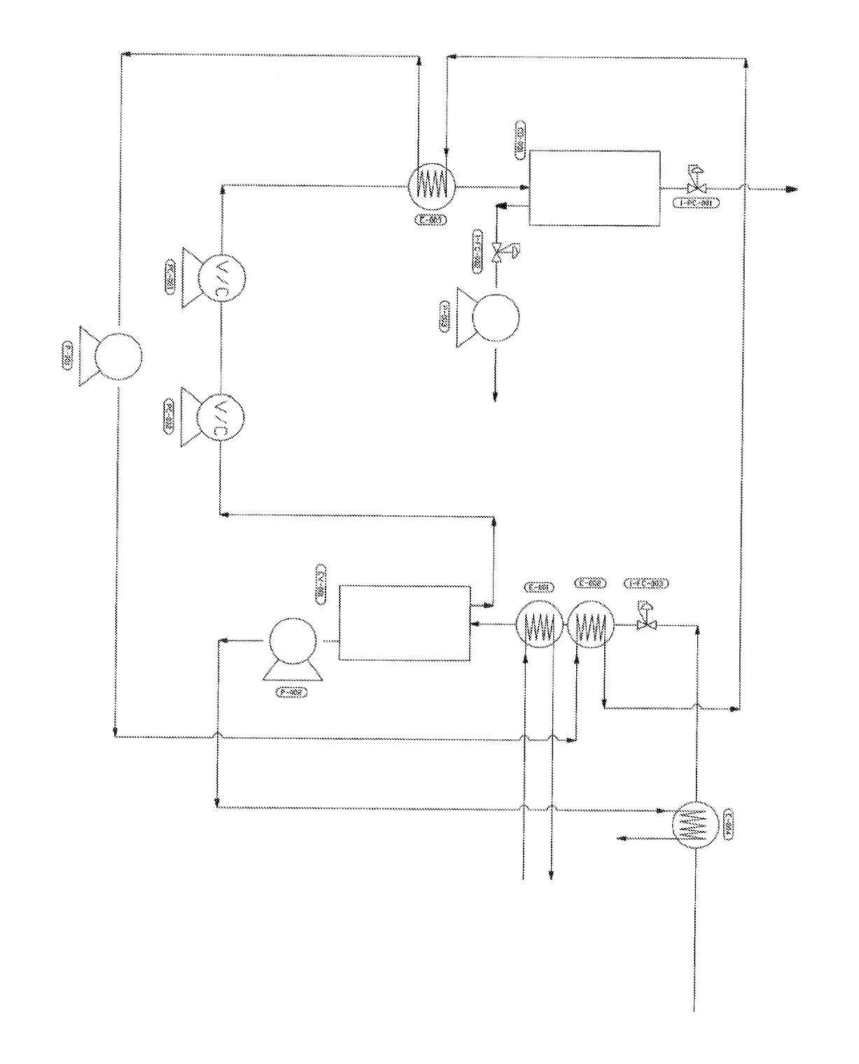

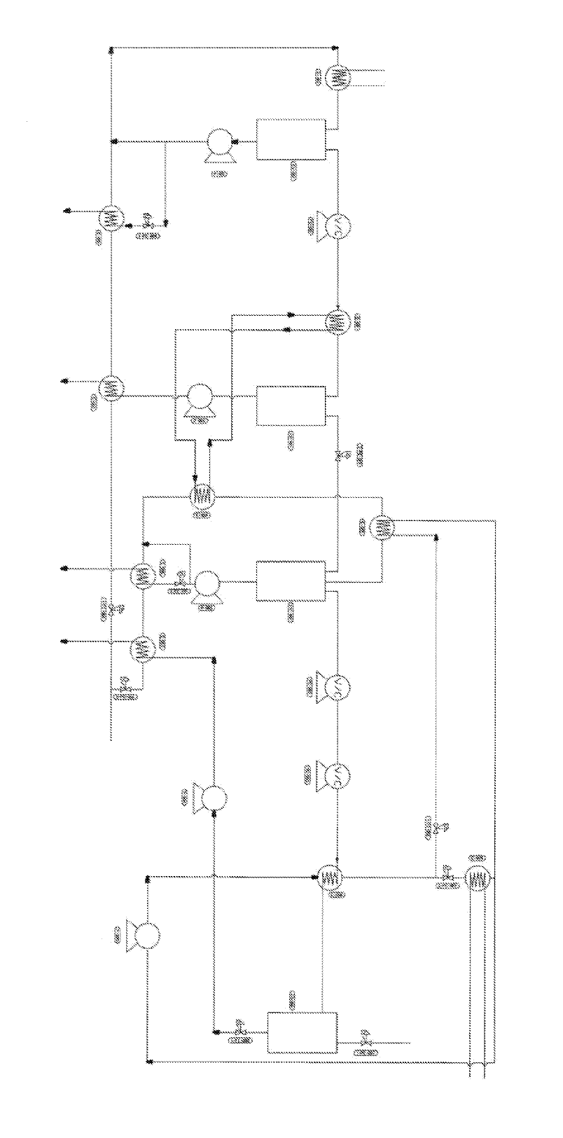

FIG. 2 illustrates a simple, open installation according to the invention, similar to the embodiment illustrated in FIG. 1, but the water loop is open and the heat pump medium, which in this embodiment means the medium to the evaporator, is seawater. The installation produces fresh water evaporated from seawater in the evaporator and brine in the form of the rest of the seawater, in addition electric energy and/or heat energy can be produced. In addition to the components in the installation according to FIG. 1, there is a flow control valve 1-FC-002 on the seawater inlet, a circulation pump P-001 on the brine outlet and an evaporator EV-001 in the cold side of the installation between the seawater inlet and the brine outlet. Steam is taken out from the evaporator, is led through the vacuum pump compressor and condenser and the pressure regulator before it is taken out as fresh water. Seawater led into the evaporator that is not evaporated is taken out as brine. The heat exchanger E-002 and any further heat exchangers, can be built together with the evaporator EV-001, these can possibly have the same function or be one unit. However, the embodiment that is illustrated can give heating of fed in water to a much higher temperature than the evaporation temperature in the evaporator, before the water evaporates under low pressure.

FIG. 3 illustrates an installation that is much like the installation according to FIG. 2, but further heat exchangers and other equipment are integrated in the installation and the condenser is split up into a separate unit behind a heat exchanger, similar to the evaporator.

FIG. 4 illustrates a more complex installation according to the invention. Seawater is pumped at 50 kg/sec via a heat exchanger E-001 to the evaporator EV-001. If one assumes that seawater has a temperature of 50° C. after E-001 and that the pressure in the evaporator EV-001 is 0.0738 [bar], the energy of the seawater between 50-40° C. will go over to steam at 40° C. Enthalpy water at 50° C.=209.3 [kJ/kg] and at 40° C.=167.5 [kJ/kg]. (209.3 [kJ/kg]—167.5 [kJ/kg])×50 [kg]=2090 [kJ/sec] phase is displaced to steam. Enthalpy steam 40° C., 0.0738=2574 [kJ/kg]. In the example, the steam production will be 2090 [kJ]/2574 [kJ]=0.8119 [kg steam/sec]. The vacuum pump compressor PC-001 raises the pressure from 0.0738 [bar] to 0.4738 [bar] (0.4 [bar] differential pressure). Then the temperature increases to 80° C. The steam will now have an enthalpy of 2643 [kJ/kg]. Supplied energy in the compression is 2643 [kJ/kg]−2574 [kJ/kg]=69 [kJ/kg]. In this example 69 [kJ/kg]×0.8119 [kg]=56.02 [kJ]. The pressure after PC-001 is regulated by the pressure regulator 1-PC-009. Now the steam holds 80° C. which we can heat exchange with seawater in a heat exchanger E-004. The steam will condense in E-004 and give the energy to the seawater. If we circulate 100 [kg/sec] of seawater in the loop 2 and have an evaporator pressure of 0.312 [bar] in the evaporator EV-002, the seawater coming from the evaporator will have a temperature of 70° C. When this seawater is heat exchanged with the steam from PC-001, the temperature will increase to (2643 kJ−293.1 kJ)×0.8111 kg=1908 kJ. 1908 [kJ/kg]/100 [kg]=19.08 [kJ/kg]. (70° C.=293.1 [kJ/kg]+190.08 [kJ/kg]=312.2 [kJ/kg]≈74.5° C.

If the temperature in the heat exchanger E-005 increases to 80° C., 335 [kJ/kg] (80° C.)−312.2 [kJ/kg] (74.5° C.)=22.8 [kJ/kg]×100 [kg]=2289 kJ must be supplied. The seawater will give out in the evaporator EV-002 (335 [kJ/kg]−293.1 [kJ/kg])×100 [kg]=4190 [kJ] which will be 4190 [kJ]/2626 kJ [kJ/kg]=1.5976 kg steam at 70° C. If the steam is compressed by 0.8 [bar] through PC-002 and PC-003, the steam will have a pressure of 1.12 [bar] and a temperature of 103° C., 2680 [kJ/kg]. The compression has supplied 2680 [kJ/kg]−2626 [kJ/kg]=54 [kJ/kg]. 2680 [kJ/kg]×1.596=4277 [kJ]. In the example 54 [kJ/kg] ×1.598 [kg]=86.2 [kJ/sec]. If 100 [kg/sec] fresh water is circulated in loop 3, at a temperature of 85° C. in the heat exchanger E-008 and the steam from PC-003 is condensed, the temperature of the circulating water will increase to 356 [kJ/kg]+37 [kJ/kg]=393 [kJ/kg]=94° C.

In this example, 2280 [kJ] of this energy is used to heat exchange to loop 2 with the help of E-005. The remaining 1429 [kJ/sec] can be “collected” from the system in one or more ways which are explained elsewhere in this document. Spent energy in vacuum pumps and compressors:

PC-001 (56 kW)+PC-002 +PC-003 (86.2 kW)=142.2 kW

We can collect 1429 kW from the system.

In addition, we have produced 0.8119 kg +1.596 kg=2.4079 kg water/sec=208042 kg water/24 hours of a quality suited to drinking water, for watering or to industry.

The installation illustrated in FIG. 4 can be constructed with further steps to compress the medium further and bring the condensing temperature higher, to be able to produce electricity efficiently. As mentioned, compressing to 5 bar (4 bar g) will give a compressing temperature of 152° C. and the condensing temperature will be 281° C. at 65 bar.

Even if the compression work and the work of the vacuum appliance influence efficiency of the installation considerably, with this installation according to the invention it is possible to produce fresh water very cheaply and even for free, and brine in addition, and it is possible to produce electricity and/or heat energy, so that the sales value of fresh water and electricity, and any residual heat, and brine, can lead to an installation that can be operated profitably.

1. A heat pump installation comprising an evaporator, a pressure regulator and a heat pump medium, as heat is collected from a cold side of the installation in that the heat pump medium is evaporated in the evaporator, gaseous fluid is lead to the condenser, wherein the installation also comprises a vacuum appliance or a compressor arranged between the evaporator and the condenser, and the heat pump medium is fresh water, saltwater or another fluid that is evaporated at a low temperature under vacuum in the evaporator or/and the installation uses steam as a feed.

2. The heat pump installation according to claim 2, wherein the vacuum appliance is a vacuum pump compressor.

3. The heat pump installation according to claim 1, wherein the heat pump medium is saltwater or fresh water in one or more steps in series.

4. The heat pump installation according to claim 1, wherein the installation comprises two or more vacuum pump compressors arranged in series.

5. The heat pump installation according to claim 1, comprising an inlet for saltwater, an outlet for fresh water and an outlet for brine (the remaining not-evaporated salt water) as the fluid fed in is saltwater in the form of seawater or brackish water.

6. The heat pump installation according to claim 1, wherein at least one of the hot side of the installation, the condenser, and one or more associated heat exchangers is connected in the heat exchange towards:
an installation for the production of electricity;
an air conditioner;
an installation with a volumetric turbine coupled to a generator;
a binary cycle;
a drying installation;
a distant heat installation; and
a heat store.

7. The heat pump installation according to claim 1, wherein at least one of the cold side of the installation, the evaporator, and one or more of the associated heat exchangers is coupled in the heat exchange to at least one of:
a sun catching installation;
a geothermal installation;
the condenser in an air condition installation;
industrial heat;
distant heat;
the condensed fluid from the warm side of the installation; and
the flow of brine out of the installation.

8. The heat pump installation according to claim 1, wherein the heat pump is connected to a damp-containing upper part of an evaporator comprising a number of horizontally lying pipe elements arranged as sun catchers, as the evaporation installation make up an evaporator.

9. The heat pump installation according to claim 1, wherein the installation uses steam from any source as a feed and comprises a vacuum pump compressor or compressors which compresses the steam in the installation to a high pressure and high condensation temperature, and the installation is connected in the heat exchange to at least one of:
an installation for production of electricity;
a kalina installation;
an installation with a volumetric turbine connected to a generator;
a binary cycle;
a drying installation;
a district heating installation;
a heat store; and
a set of turbine generators placed directly in the steam stream.

10. A heat pump installation comprising a vacuum pump compressor or compressors which compresses a feed in the installation in the form of steam to a high pressure and high condensation temperature, and the installation is connected in heat exchange to at least one of:
an installation for production of electricity;
a kalina installation;
an installation with a volumetric turbine connected to a generator;
a binary cycle;
a drying installation;
a district heating installation;
a heat store; and
a set of turbine generators placed directly in the steam stream.

11. The method for the operation of an installation according to claim 1, wherein seawater is fed into an evaporator where the underpressure leads to evaporation of fresh water at a reduced temperature, while the remaining brine is led out.

12. The method according to claim 10, wherein seawater is fed in in an amount which in total corresponds to the freshwater condensed from the water steam and removed and the remove brine, and at least one of electrical energy and heat energy is produced in the installation in addition to fresh water and brine.

13. The method according to claim 10, wherein necessary through-flow of saltwater/brine is maintained to prevent the deposition of salt and blooming of algae in the evaporator.

14. (canceled)

15. The heat pump installation according to claim 3, wherein the heat pump medium is saltwater in an open installation which thereby leads to production of fresh water.

16. The heat pump installation according to claim 3, wherein the heat pump medium is fresh water in a closed installation which can thereby produce electricity efficiently.

17. The heat pump installation according to claim 3, wherein the heat pump medium is saltwater.

18. The heat pump installation of claim 5, wherein the fresh water is of a quality suited to agriculture, industry, or drinking water.

19. The heat pump installation of claim 5, wherein the brine can be used as feed water in an installation for salt production.

20. The heat pump installation according to claim 1, wherein at least one of the hot side of the installation, the condenser, and one or more associated heat exchangers comprises at least one of:
an installation for the production of electricity;
an air conditioner;
an installation with a volumetric turbine coupled to a generator;
a binary cycle;
a drying installation;
a distant heat installation; and
a heat store.

21. The heat pump installation according to claim 6, where the installation for the production of electricity utilizes a Rankin cycle.

22. The heat pump installation according to claim 20, where the installation for the production of electricity utilizes a Rankin cycle.

23. The heat pump installation according to claim 1, wherein the installation uses steam from any source as a feed and comprises a vacuum pump compressor or compressors which compresses the steam in the installation to a high pressure and high condensation temperature, and the installation is connected in the heat exchange to at least one of:
an installation for production of electricity;
a kalina installation;
an installation with a volumetric turbine connected to a generator;
a binary cycle;
a drying installation;
a district heating installation;
a heat store; and
a set of turbine generators placed directly in the steam stream.

24. The heat pump installation according to claim 9, where the installation for the production of electricity utilizes a Rankin cycle.

25. The heat pump installation according to claim 23, where the installation for the production of electricity utilizes a Rankin cycle.
